(19) United States
(12) Patent Application Publication
(10) Pub. No.: US 2003/0135676 A1
(43) Pub. Date: Jul. 17, 2003

(54) Low-power bus interface

(75) Inventor: Jensen Hartrung Jensen, San Francisco, CA (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 10/052,277

(22) Filed: Jan. 17, 2002

(51) Int. Cl. G06F 13/00

(52) U.S. Cl. 710/107

(57) ABSTRACT

A system is configured to disable the bus interface of target devices during periods of inactivity on a bus. A bus controller processes data and control signals from an initiator to establish an initiator-to-target communications path for data-transfer to or from the initiator. At the same time that the bus controller is processing the data and control signals, an activity detector notes the occurrence of the request from the initiator, and enables the bus interface on each of the targets. When the target signals a completion of the data-transfer operation, the activity detector notes the occurrence of the completion signal from target and disables the target interfaces of each target. To provide a substantial reduction in power consumption, the enabling and disabling of the target interfaces is effected by controlling the propagation of the clock system clock to each target interface. The single activity detector is continually active, to detect each data-transfer initiation as it occurs, and effectively eliminates the need for each of the individual target bus interfaces to perform this continual monitoring function.

### BACKGROUND OF THE INVENTION

1. Field of the Invention

This invention relates to the field of system and circuit design, and in particular, to a bus interface control structure that allows for low power consumption.

2. Description of Related Art

For ease of understanding, this invention is presented using the paradigm of an “initiator” of a bus transaction, and a “target” of the communications with the initiator. A functional component on the bus may be an initiator or a target, or both. A memory component, for example, is typically only a target, because a memory component does not generally initiate data transfers. A CPU in a single processor system, on the other hand is typically an initiator, because it generally determines what communications will take place. If, however, the CPU allows interrupts via the bus structure, it will be a target for the initiator of the interrupt. Note that, using this paradigm, the role as initiator and target is independent of the desired direction (read/write, transmit/receive) of data transfer.

Conventionally, a substantial amount of power consumption in a high-speed system is the power required for maintaining bus communications. Each initiator may be configured to enter a low-power mode until it is ready to initiate a communication, but each target must be continually ready to react to the initiated communication. In a high-speed system, each potential target continually samples the bus, to determine whether it is being addressed, and to receive the data without introducing a delay to the data transfer sequence from the initiator. This is particularly important in synchronous or near-synchronous bus designs, or pipe-lined designs, wherein each of the devices is assumed to operate in lock-step with each other to effect data transfers.

In a number of applications, data transfers via the bus are somewhat infrequent. A common technique for reducing the power consumed by the bus interfaces is to enter a low-power mode during periods of inactivity. The low-power mode is typically achieved by substantially reducing the speed of the clock that is used at the interfaces to the bus. Although this power-saving technique can substantially reduce the power used by the bus structure, it introduces a latency each time a bus transfer is initiated, while the clock is reset to its original high-speed operation.

### BRIEF SUMMARY OF THE INVENTION

It is an object of this invention to provide a system architecture and method that reduces power consumption. It is a further object of this invention to provide a system architecture that provides a low-power-consuming bus architecture that operates at high speed. It is a further object of this invention to provide a low-power-consuming bus structure that operates with minimal data-transfer latency.

These objects, and others, are achieved by providing a system architecture and method that is configured to disable the bus interface of target devices during periods of inactivity on a bus. A bus controller processes data and control signals from an initiator to establish an initiator-to-target communications path for data-transfer to or from the initiator. At the same time that the bus controller is processing the data and control signals, an activity detector notes the occurrence of the request from the initiator, and enables the bus interface on each of the targets. When the target signals a completion of the data-transfer operation, the activity detector notes the occurrence of the completion signal from target and disables the target interfaces of each target. To provide a substantial reduction in power consumption, the enabling and disabling of the target interfaces is effected by controlling the propagation of the clock system clock to each target interface. The single activity detector is continually active, to detect each data-transfer initiation as it occurs, and effectively eliminates the need for each of the individual target bus interfaces to perform this continual monitoring function.

### BRIEF DESCRIPTION OF THE DRAWINGS

The invention is explained in further detail, and by way of example, with reference to the accompanying drawings wherein:

FIG. 1 illustrates an example block diagram of a system that provides for minimal power consumption during periods of bus inactivity in accordance with this invention.

FIG. 2 illustrates an example flow diagram for data transfer via a system that provides for minimal power consumption during periods of bus inactivity in accordance with this invention.

FIG. 3 illustrates an example block diagram of a clock controller for providing a gated clock to bus interface devices in accordance with this invention.

Throughout the drawings, the same reference numerals indicate similar or corresponding features or functions.

### DETAILED DESCRIPTION OF THE INVENTION

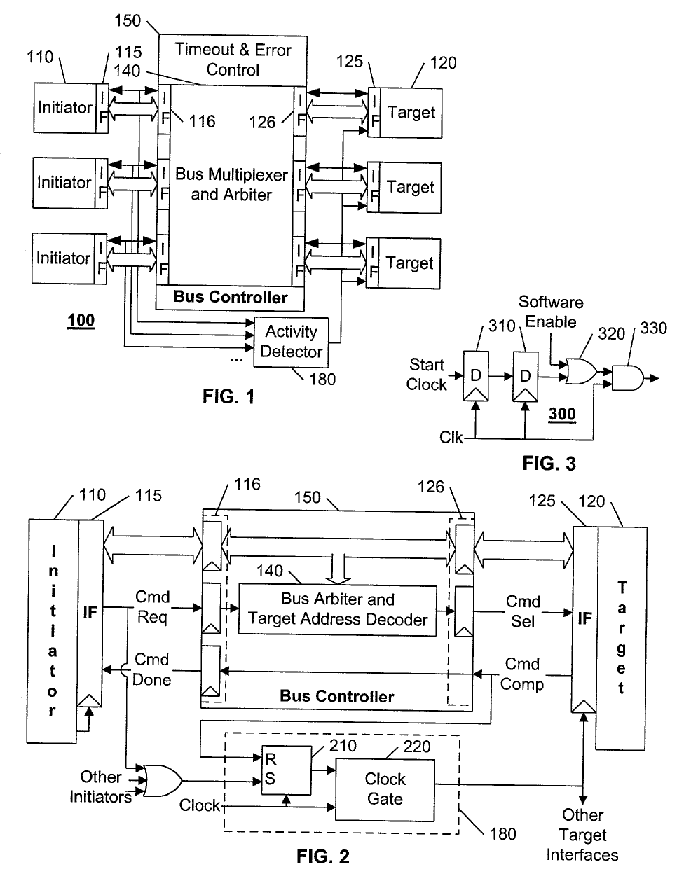

FIG. 1 illustrates an example block diagram of a system 100 that provides for minimal power consumption during periods of bus inactivity in accordance with this invention. The system 100 includes a plurality of functional components that communicate with each other via the bus structure. As noted above, the invention is presented using the paradigm of an initiator 110 of a bus transaction, and a target 120 of the communications with the initiator 110. A functional component may be an initiator 110 or a target 120, or may be both an initiator 110 and a target 120. As also noted above, the role as initiator 110 and target 120 is independent of the desired direction (read/write, transmit/receive) of data transfer.

Also for ease of reference, this invention is presented in the context of a bus structure that uses a centralized bus controller 150 that manages bus activities, including bus multiplexing and arbitration, timeout and error control, and so on. As will be evident to one of ordinary skill in the art, the principles of this invention are applicable to bus structures with distributed bus control, wherein, for example, the arbitration and multiplexing functions are achieved by having each component cooperate to minimize bus contention.

Bus architectures include both “broadcast” buses and “directed” buses. In a broadcast bus, multiple components are commonly connected directly to the bus, so that the data that is presented to the bus is available to each of the components. In a directed bus, the interface to the bus is via a multiplexer that selects which devices are connected to the bus at a given point in time. The example system 100 of FIG. 1 illustrates a bus structure that includes a directed bus for communications with the bus controller 150, although one of ordinary skill in the art will recognize that the principles of this invention are applicable as well to broadcast bus structures, or combinations of broadcast and directed bus structures.

Each of the components 110, 120 of the system 100 includes an interface adapter 115, 125, respectively, for communicating via the bus. The communications via the bus include data, which is indicated by the wide arrow symbols, and control signals, which are indicated by single width arrow symbols. Each interface adapter 115, 125 has a corresponding interface module 116, 126 at the bus controller 150.

In accordance with this invention, an activity detector 180 is configured to receive a notification that an initiator 110 has initiated a data-transfer process. Based on this notification, the activity detector enables the interfaces of each of the targets 120, in anticipation of the data-transfer request, and the associated command and data, being communicated to at least one of the targets 120.

In a conventional system, each target typically contains circuitry in its interface that continually monitors the bus for activity. The target may be configured to operate in a low-power mode until such activity is detected, but the circuitry in the interface must be configured to continually monitor the bus. For a variety of reasons, including decreased noise and transient sensitivity, the monitoring of the bus is achieved by periodically clocking registers that read the contents of the bus. As is known in the art, particularly in low-power CMOS designs, the power consumption of a system is substantially dependent upon the frequency of each clock in the system, and number of devices that are clocked by each of these clocks.

This invention is based on the observation that, substantial power savings can be achieved by providing a common activity detector 180 that enables each target 120 when activity is detected, rather than continually monitoring the bus for activity at each target 120.

In a preferred embodiment of this invention, the activity detector 180 is configured to inhibit the propagation of the system clock to the target devices interfaces 125. In this manner, the number of devices clocked by the system clock is substantially reduced. That is, rather than reducing the system clock frequency to reduce power consumption, the architecture of this invention reduces the number of devices clocked by the system clock, during periods of inactivity. Thus, provided that the typical system operation is characterized by periods of bus inactivity, substantial power savings can be achieved. Even if there is only one target 120, the common activity detector 180 will provide a power savings during inactive periods, because the typical interface 125 contains well over a dozen clocked registers for receiving the myriad assortment of control and data signals used to provide data-transfers, whereas, as presented further herein, an activity detector 180 of this invention may include fewer than two clocked devices. If there are multiple targets 120, the power savings provided by a single activity detector 180 is even greater.

To avoid latency caused by having to enable the targets after the activity detector 180 detects activity on the bus, the activity detector 180 is configured to receive a pre-notification of activity on the bus, before the targets 120 receive the initial commands or data from the initiator 110. If an explicit bus controller 150 is employed, there will be a predeterminable delay between the time that the initiation signal is received by the bus controller and the time that a particular target 120 is selected as the target of the transfer. In a preferred embodiment of this invention, the activity detector 180 receives the pre-notification signal at the same time that the bus controller 150 receives the bus request signal, and is configured to provide an up-to-speed activation of the target interfaces 125 within this predeterminable delay. If an explicit bus controller 150 is not used, each initiator 110 is configured to provide a pre-notification signal to the activity detector 180, before it communicates command or data information to the bus. This pre-notification signal is provided sufficiently ahead of the command and data information so as to allow the target interfaces 125 to be brought up-to-speed by the time that the command or data information arrive at the target interfaces 125.

FIG. 2 illustrates an example flow diagram for data transfer via a system that provides for minimal power consumption during periods of bus inactivity in accordance with this invention. The flow diagram illustrates a configuration of the system 100 of FIG. 1 during communications between an initiator 110 and a target 120. The example structure illustrated in FIG. 2 is presented for illustration purposes, and is intended to represent a fairly conventional control and data flow process, or protocol, wherein an initiator 110 initiates a communication by asserting a command-request control signal and the addressed target 120 acknowledges an execution of the command by asserting a command-complete control signal. Other communications protocols are common in the art, and the application of the principles of this invention to these other protocols will be evident to one of ordinary skill in the art in view of this disclosure.

In the configuration of FIG. 2, the initiator 110 simultaneously transmits a command-request control signal and a command to the bus controller 150, via the interface 115. The bus arbiter and address decoder 140 receives this information and allocates the bus to the initiator 110. At the same time, the arbiter and decoder 140 decodes a target address that is contained in the command, and asserts a command-select signal to the addressed target 120, which is received at the interface 125. The target 120 processes the command, typically a read or write data transfer command, which contains an indicated address within the target 120 for this data transfer. When the target 120 is ready to effect this command, the target 120 asserts a command-complete control signal to the bus controller 150 via the interface 125, which is subsequently communicated to the initiator 110, and received at the interface 115.

If the command is a write command, for transmitting data from the initiator 110 to the target 120, the data that is to be transmitted is presented at the interface 115 at the same time that the write command-request signal is asserted by the interface 115. The target 120 then accepts the data, which is present at the interface 126 when the corresponding command-select control signal is received at the interface 125, and asserts the command-complete control signal via the interface 125. Upon receipt of the corresponding command-done control signal at the interface 115, the initiator 110 is free to release the bus by deasserting the command-request control signal, and need no longer maintain the address and data signals at the interface 320.

If the command is a read command, for receiving data from the target 120 at the initiator 110, the data that is to be transmitted is presented at the interface 125 of the target 120 at the same time that the target 120 asserts the command-complete control signal at the interface 125. When the corresponding command-done signal is received at the interface 115 of the initiator 110, the initiator 110 accepts the data via the interface 115.

As detailed above, the flow illustrated in FIG. 2 provides an efficient data-throughput rate, by simultaneously providing control signals and data or commands corresponding to these control signals. To achieve this efficiency, each receiving interface must be operating at the system clock speed when the control signals and data and commands are available at the corresponding transmitting interface. As illustrated in FIG. 2, the interface 115 of the initiator 110 is configured to be controlled by the initiator 110; in this manner, consistent with conventional power-saving options, the interface 115 can be deactivated until the initiator 110 is ready to initiate a data-transfer operation. However, because the initiation of a data-transfer operation may occur at any time, the other interfaces 116, 126, 125 in a conventional system are operated continually, to detect the initiation.

In the flow diagram of FIG. 2, an activity detector 180 is configured to receive the command request control signal from the initiators 110. If any initiator 110 asserts a command request signal to initiate a data-transfer, the set-reset latch 210 is set. As detailed further below with regard to an example clock gate of FIG. 3, the clock gate 220 is configured to propagate the system clock to the target interfaces 125 when the input to this gate 220 is asserted. Provided that the propagation of the system clock through the activity detector 180 occurs within the time that the control signals and data and commands are propagated through the bus controller 150, the interface 125 of each target 120 will be operating at the system clock speed when the control signals and data and commands are available at the interface 126 of the bus controller 150.

When the target 120 signals a completion of the operation directed by the data-transfer command, the set-reset latch 210 is reset, or cleared. In response to this de-assertion, the clock controller inhibits the propagation of the system clock to the target interfaces 125, thereby reducing the power consumed after each data-transfer operation, as detailed above.

As will be evident to one of ordinary skill in the art, the principles of this invention are independent of the particular logic and structure of the activity detector 180 of FIG. 2. The function of the activity detector is to re-enable the bus interfaces 125 at each target 120 by the time that the control and data and commands arrive at the interfaces 125, and can be effected in any of a variety of means, and the function can be distributed among a variety of blocks. For example, each interface 125 could be configured to receive the system clock as a direct input, and the output of the gate 220 of FIG. 2 as an input. The gate 230 in this example would then be located in each of the target interfaces 125. By providing an ungated system clock and a clock-gating signal to each interface 125, each interface 125 can be selectively configured to use the power-saving option of this invention for some or all of the components in the particular target interface 125. For example, the registers in a particular interface 125 that are used for receiving control signals may be configured to use the ungated system clock, while the registers that are used for communicating data and commands may be configured to use the gated clock output of the gate 230 within the particular interface 125. In like manner, the enable-override gate 220 may be included in each target interface 125, so that each target 120 can be selectively placed in a low-power mode. If, for example, due to the particular placement of a target 120 in the layout of the system, the propagation delay of the clock-gating signal to the target 120 is excessive, this particular target 120 can be configured to forego the power-savings and remain in a continuous monitoring mode for more reliable operation. These and other system configuration and optimization options will be evident to one of ordinary skill in the art in view of this disclosure. For example, other components, such as select registers within the bus controller 150 may also be configured to be operated based on the clock-gating signal from the activity detector 180 to further reduce the power consumption of the system.

FIG. 3 illustrates an example block diagram of a clock controller 300 for providing a gated clock to bus interface devices in accordance with this invention. The controller 300 includes one or more delay devices 310 that propagate the clock enable signal to the gate 330 to enable the propagation of the input clock to the target interfaces. In a preferred embodiment of this invention, the clock controller 300 also includes a gate 320 that allows a propagation of the system clock via an external control, such as a software control.

Preferably, at least one delay element 310 is provided, to prevent ‘glitches’ from occurring on the gated-clock output of the controller 300. In the example controller 300 of FIG. 3, two delay elements 310 are illustrated, to provide a “double synchronization”, to avoid loss of synchronization caused by a potential metastable input condition, primarily when the start-clock signal is deasserted. That is, the delays 310 are provided to assure that the target interfaces 125 are not disabled until both the initiator 110 and target 120 have completed the data-transfer operation.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

I claim:

1. A system comprising:
a plurality of components,
a bus structure that is configured to facilitate communications among the plurality of components, and
an activity detector that is configured to detect an initiation of a data-transfer operation and to provide therefrom an enabling signal that is communicated to a bus interface of at least one of the plurality of components,
wherein
the bus interface is configured to be enabled to receive data from the bus structure upon receipt of the enabling signal from the activity detector.

2. The system of claim 1, wherein
the activity detector is further configured to detect a completion of the data-transfer operation, and terminates the enabling signal based on the completion of the data-transfer operation, and
the bus interface is configured to be disabled from receiving data from the bus structure upon termination of the enabling signal.

3. The system of claim 1, wherein
the enabling signal includes a gated clock signal.

4. The system of claim 1, wherein
the bus interface includes a plurality of clocked devices that are clocked based on the enabling signal.

5. The system of claim 1, wherein
the activity detector includes:
a set-reset device that is set upon detection of the initiation of the data-transfer operation, and
a delay device, operably coupled to the set-reset device, that is configured to provide the enabling signal synchronous with a system clock that is common to the bus structure, based on whether the set-reset device is set.

6. The system of claim 5, wherein
the set-reset device is reset upon detection of a completion of the data-transfer operation.

7. The system of claim 1, further including
a bus controller that is configured to establish a communications path between an initiating component of the plurality of components and a target component of the plurality of components,
wherein
the activity detector provides the enabling signal within a time duration consumed by the bus controller to establish the communications path.

8. The system of claim 7, wherein
the bus controller includes one or more devices that operate in dependence up the enabling signal.

9. The system of claim 1, wherein
a component of the plurality of components is configured to signal the initiation of the data-transfer operation to the activity detector before the component initiates the data-transfer operation via the bus structure.

10. A method of reducing power consumption in a system comprising a plurality of components that are configured to communicate via a bus structure, comprising:
detecting an initiation of bus activity by a component of the plurality of components,
communicating an enabling signal to one or more other components of the plurality of components, and
enabling a bus interface at each of the one or more other components to receive signals corresponding to the bus activity, based on the enabling signal.

11. The method of claim 10, further including
detecting a completion of the bus activity, and
disabling the bus interface at each of the one or more other components, based on the completion of the bus activity.

12. The method of claim 10, further including
synchronizing the enabling signal to a system clock that is common to the bus structure.

13. The method of claim 10, further including
establishing a communications path between the component that initiated the bus activity and a target component of the one or more other components, and
enabling the bus interface at the target component within a time duration required to establish the communications path.

14. The method of claim 13, wherein
the enabling of the bus interface is independent of establishing the communications path.

15. An electronic circuit comprising:
a plurality of initiators that are configured to selectively initiate data-transfer operations via a bus structure,
a plurality of targets that are configured to process the data-transfer operations,
each of the plurality of targets including an interface for receiving the data-transfer operations, and
an activity detector that is configured to detect an initiation of a data-transfer operation from any of the plurality of initiators, and to generate therefrom an enabling signal, wherein
the interface of each of the plurality of targets is configured to receive the data-transfer operations in dependence upon the enabling signal from the activity detector.

16. The electronic circuit of claim 15, wherein
the plurality of initiators are configured to effect the data-transfer operations at a system clock speed, and
the interface of each of the plurality of targets is configured to operate at the system clock speed only when the activity detector provides the enabling signal.

17. The electronic circuit of claim 16, wherein
the enabling signal includes a clocking signal that operates at the system clock speed.

18. The electronic circuit of claim 15, wherein
the activity detector is further configured to detect the completion of the data-transfer operations, and to terminate the generation of the enabling signal based on the completion of the data-transfer operations.

19. The electronic circuit of claim 15, further including
a bus controller that is configured to establish a communications path between an initiator of the plurality of initiators and a target of the plurality of targets, wherein
the activity detector is configured to generate the enabling signal within a time duration required by the bus controller to establish the communications path.
